(19) United States
(12) Patent Application Publication
(10) Pub. No.: US 2005/0081440 A1
(43) Pub. Date: Apr. 21, 2005

(54) Method and apparatus for growing pains

(76) Inventors: Gertus De Sauvage, Rotterdam (NL); Anton Blaakmeer, Le Venray (NL)

Correspondence Address: Dickstein Shapiro;Morin & Oshinsky, 41st Floor, 1177 Avenue of the Americas, New York, NY, 10036-2714, US

(21) Appl. No.: 10/482,916

(22) PCT Filed: Jul. 11, 2002
(86) PCT No.: PCT/EP02/07741

(30) Foreign Application Priority Data
Jul. 13, 2001 (GB) 0117183.4

(51) Int. Cl. A01G 31/00

(52) U.S. Cl. 47/62 A

(57) ABSTRACT

The invention provides a method of growing plants comprising supplying water to the plants so that the plant roots contact a body of water and drawing water through a suction device (3) provided in contact with the body of water and into a first conduit (4) connected at one end to the suction device (3) and through the first conduit (4) into a second conduit (5) connected to the other end of the first conduit (4), characterised in that the second conduit (5) is at least partially filled with air and the water is released from the first conduit (4) into air space in the second conduit (5). The invention also provides an apparatus suitable for carrying out the method.

The invention relates to methods for growing plants in which the rate of flow of irrigation water through the environment of the plant roots is controlled. In particular it relates to methods in which the plants are grown in a growth substrate, in particular a mineral wool growth substrate. It also relates to an apparatus for carrying out the method.

It is well known to cultivate plants in a natural or artificial growth substrate, in particular a mineral wool growth substrate, such as rock wool or glass wool. Water and, if necessary, fertiliser and other additives are supplied to the growth substrate, generally by causing water, optionally containing fertiliser and other additives, to flow through the substrate. It is important that the plants receive an adequate supply of water, of oxygen and of other materials such as fertiliser which are carried by the water.

Water is one of the means by which oxygen is carried into the growth substrate. In particular, if water is supplied from a dripper positioned above a mineral wool growth substrate, the drops falling onto the substrate are highly oxygen-rich. This oxygen is carried into the substrate and taken up by the roots of the plant. Therefore if the growth substrate becomes low in oxygen this can be alleviated by supplying more water.

Similar considerations apply to other additives dissolved in the water, such as fertiliser. A greater rate of flow of water into the substrate increases the rate of supply of additives carried by the water.

It is advantageous to have adequate water flow for other reasons. Increased water flow leads to increased turbulence around the roots which increases the rate of transfer of beneficial components such as water and fertiliser into the roots. Flow of water also removes undesirable by-products released into the growth substrate by the plants.

However, merely increasing the rate of supply of water to the growth substrate can cause problems. In particular, the maximum flow rate is normally determined by the maximum flow rate of water through the growth substrate under gravity. If the rate of supply of water exceeds this through-flow rate then excess water simply overflows.

It is possible to modify the growth substrate so as to obtain a higher maximum through-flow rate. However, this generally requires reduction in growth substrate density, in particular in the case of mineral wool. This in itself leads to an inferior water distribution through the substrate. The water level at the top of the growth substrate is much lower than at the bottom of the growth substrate. The top can become too dry and the bottom can become over-saturated.

It would be desirable to actively control the rate of flow of water through the substrate. Our earlier publications EP-A-300,536 and BP-A-409,348 disclose active water flow systems.

EP-A-300,536 discloses a system in which water flow through the growth substrate is controlled by a capillary system. Water conduits extend into the growth substrate and connect with a water pump. This is set at a predetermined rate to pump water out of the substrate. The conduit system is substantially filled with water and the flow rate is determined essentially by the rate set for the water pump. This publication discusses “suction pressure” but this is in the context of the force required to be exerted by the plant to remove water from the substrate. High “suction pressure” in this sense correlates with low substrate water content and the aim of this publication is to maintain an appropriate substrate water content and consequently appropriate suction pressure.

EP-A-409,438 relates to the same water pump system. Additionally it provides coupling members between the conduit system and the growth substrate. The intention of these is to prevent growth of plant roots into the conduit system. It is stated that an advantage of the coupling members is that they remain more moist than the surrounding growth substrate and prevent air entering the conduit system from the slab side.

Although both of these systems are effective and useful, there is room for improvement in certain areas. In particular, the previously described systems require that the surface on which the plants are grown, eg the floor of a greenhouse, is almost exactly horizontal. Otherwise the pressure in the system and the water flow rate vary according to the height at which a slab of growth substrate (eg mineral wool) is positioned. A further potential problem lies in the fact that the conduit system is substantially filled with water. Thus there is an unbroken water pathway from one plant to any other plant in the system. This has the potential to allow transfer of plant viruses and other infections throughout the entire crop.

Another known system for growing plants is known as the nutrient film technique (NFT) system. In this system plants are grown in small propagation blocks or even in no substrate at all, the plants, and blocks if used, being contained in a plastic container, such as a plastic film container. Water drips into the container and into the propagation block if used and is drained from the plastic container via holes. Such systems suffer from the problem that the drainage process is significantly affected by the evenness of the surface on which the plants are grown. An uneven surface results in uneven drainage and different plants are subject to different degrees of saturation.

According to the invention we provide a method of growing plants comprising providing plants, supplying water so that the plant roots contact a body of water and drawing water through a suction device provided in contact with the body of water in the growth substrate and into a first conduit, drawing the water through the first conduit and into a second conduit, characterised in that the second conduit is at least partially filled with air and the first and second conduits are connected so that the first conduit releases into the air space in the second conduit. In preferred embodiments the pressure in the conduits is controlled by an air pump.

That is, the invention comprises a liquid drawing and air locking device which is integrated within a growth system and which is part of a conduit system which uses a cavity partly filled with liquid and partly filled with air to induce controlled release of liquid from the substrate. The liquid drawing and air locking device is generally in the form of a suction device such as a suction plug inserted into the growth substrate. The suction device is capable of forming an airlock when pressure in the conduit system tends to draw air through it. As the pressure drawing water into the system increases the flow of water increases, generally up to a drawing force of at least 30 cm water column.

The pressure can increase up to a drawing force at which the suction device releases air into the first conduit rather than water because the force tending to draw water into the system is greater than the force holding water in the suction device.

In a particularly preferred embodiment of the invention the plants are provided in a growth substrate, water is supplied to the growth substrate and drawn from the growth substrate through the suction device, which is provided in the growth substrate. Thus the liquid drawing and air locking device is preferably integrated within the growth substrate.

In the invention the force drawing water into the conduit system is controlled by air pressure. This is in contrast with the systems of EP-A-300,536 and EP-A-409,348 in which the movement of water from the growth substrate into the conduit system is controlled by water flow and is thus influenced by the relative heights of the growth substrate slabs such that if the system is to be effective the slabs must all be on the same level. In the invention it is not necessary to provide a level surface and thus the system may be applied easily and straightforwardly in any greenhouse without requiring levelling of the floor first.

Furthermore, the first conduit releases into air space in the second conduit. In a preferred embodiment at least two and preferably a large number of conduits are provided, each connected with a suction device in contact with the body of water which contacts the roots of the plants. When the plants are grown in a growth substrate, it is common to provide a large number of slabs each containing one or a small number of plants. In this case, each suction device is generally associated with a single slab, and in some cases one suction device can be associated with each plant. Thus although it is possible that viruses and other infectious agents from one plant may be drawn from the growth substrate into the first conduit and then released into the second conduit, there is no water pathway between the second conduit and other first conduits associated with other plants. Thus the risk of transfer of viruses or other infectious agents is much reduced.

With the invention it is possible to control the flow of water through the environment surrounding the plant roots, eg. a growth substrate, simply by means of modifying the pressure in the conduit system by the air pump and obtain the consequent advantages discussed above, such as control of oxygen supply rate, supply rate of other additives, control of water content, pH, EC (electrical conductivity), nutrients such as nitrogen and microelements, and removal of undesirable by-products. It is also possible to achieve this with a high density growth substrate which gives good water distribution but without the disadvantages of the EP-A-300,536 and EP-A-409,348 systems.

It is possible to change the air pressure within the conduit system quickly and easily and thus modify f low rates and water content without difficulty.

If a growth substrate is used and the suction device is placed at the bottom of the growth substrate then water is drawn from the bottom of the substrate and the tendency to water saturation at the bottom of the substrate is reduced.

The invention also provides an apparatus suitable for use in growing plants. This comprises a growth environment adapted to contain plants and water such that the plant roots are in contact with a body of water, the growth environment being provided with a suction device arranged to draw water from the growth environment and connected to a first conduit at one end of the first conduit. The first conduit is connected at its other end to a second conduit and the apparatus comprises means for draining water from the second conduit. The apparatus also preferably comprises an air pump arranged to control the air pressure in the conduit system and the apparatus is sized such that the second conduit is at least partially filled with air in use.

As in the method of the invention, the growth environment is preferably a growth substrate and the suction device is preferably provided in the growth substrate.

### BRIEF DESCRIPTION OF THE DRAWINGS

FIG. 1 shows a schematic view of an apparatus according to the invention.

FIG. 2 shows a cross-section through part of an apparatus according to the invention.

FIG. 3 shows a different cross-section through part of an apparatus according to the invention.

FIG. 4 shows a further schematic view of an apparatus according to the invention.

FIG. 5 shows a comparison between plant weights achieved using watering methods according to the invention in comparison with two standard prior art watering methods.

The plants are generally commercial crops of the type grown in greenhouses. The crop may for instance be a commercial crop, eg lettuce, tomato, cucumber or sweet pepper.

According to a preferred aspect of the invention plants are grown in a growth substrate. Any natural or artificial growth substrate can be used, for instance soil, peat, perlite or man-made vitreous fibres (MMVF), and mixtures of any of these. Preferably the growth substrate is formed from mineral wool such as glass wool or, preferably, rock wool.

A mineral wool growth substrate may be made in conventional manner by providing a mineral melt and forming fibres from the melt. During production of the fibres or, less preferably, after production of the fibres, binder may be applied to the fibres.

The growth substrate preferably contains a wetting agent. This may be used in addition to the binder. Alternatively, a single material may be used which acts as binder and wetting agent.

The growth substrate may contain other additives known in the art for modifying and improving properties, such as clay or lignite.

In one embodiment the growth substrate is in the form of a series of small propagation blocks, each containing one plant, and the propagation blocks are contained in a plastic container such as plastic sheeting. This is one embodiment of the NFT system discussed above.

Another embodiment of the NFT system does not use growth substrate at all. Instead the plants are grown with their roots in contact with a body of water contained within a plastic container such as plastic sheeting.

In the method water is supplied to the plants, eg. to the growth substrate where one is used. This may be by any conventional means, eg drip feeding. This method is particularly preferred because the water is oxygen-rich when it reaches the environment of the plants, eg. growth substrate. Irrigation may be continuous or periodic. The water may contain fertilisers, biologically active additives such as fungicides, and other additives.

In the invention it is essential that the body of water in contact with the plant roots is in contact with a suction device. In this specification a “suction device” is a device which is capable of drawing water from the growth substrate. That is, it is capable of taking in water against pressure. Thus, although the invention can include a system for applying vacuum or pumping the suction device is such that this is not essential and water can be taken in without it. In particular it is capable of drawing water from the growth substrate by capillary force.

Preferably the suction device is made of a porous material. Examples include stone, ceramic, mineral wool and in particular porous glass. Alternatively, the suction device may be made from organic material, such as polymer foam or polymer fibres. Such a material will be configured so that the pore size is sufficiently small that the required capillary action can be obtained.

The suction device should hold water more tightly than air. Preferably it holds water against a force of at least 5 cm water column, preferably at least 10 cm water column, more preferably at least 20 cm water column, most preferably at least 30 cm water column. Some may hold water against a force of up to 200 cm water column.

The ability of the suction device to hold water can be greater or lesser according to the nature of the growth substrate (when used). For instance when the growth substrate is stone wool suction devices capable of holding water against a force of at least 5 cm water column give acceptable results. However, where the growth substrate is soil best results are achieved when the suction device holds water against a force of at least 50 cm water column.

Where the pressure in the second conduit is below atmospheric (preferred), generally the suction device holds water more tightly than air at a water column value determined by the elevation of the second conduit above the suction device subtracted from the difference in pressure in the second conduit below atmospheric (often referred to as the underpressure). In practice, the suction device must hold water against a force substantially equal to the underpressure in the second conduit.

When a growth substrate is used, preferably the porous material has average pore size smaller than the average pore size of the growth substrate.

The suction device may be formed from any of the materials discussed above but we have found that certain types of stone, especially volcanic stone, are suitable. In order to determine whether any particular material would be suitable as the material for a suction device it is simply necessary to test its ability to hold water against the water column values above.

The suction device can be described as substantially air locking. That is, it does not permit substantial passage of air through the body of water in contact with the roots (ie through the growth substrate if used) and into the first and second conduits.

In the invention the air pressure in the first and second conduits is generally predetermined and is preferably below atmospheric pressure. Entry of air into the second conduit through the suction device will effect and modify this pressure to some extent. This also has the effect of subjecting different suction devices in a single system to different air pressures, which the invention seeks to avoid. However, in systems in which the pressure is significantly below atmospheric eg about 0.5 bar (5000 cm water column) then a low degree of passage of air into the lateral conduit through the suction device is not problematic. Thus the suction device is air locking to the extent that it prevents entry of substantial amounts of air into the second conduit which have a substantial effect on the air pressure in the second conduit.

Certain types of stone prevent growth of algae and bacteria. These types are preferred.

The suction device generally has a total volume of from around 2 to 100 cm³.

Usually the suction devices are provided as separate entities within individual slabs of growth substrate (each slab containing one or a small number of plants) or separately within a large slab (containing many plants), each suction device being associated with one small slab or a small number of plants within a large slab.

Suction devices of this nature can be described as “suction plugs”. The devices may take any shape or size. Generally the suction device is of generally cylindrical or oblong shape. However it need not be a single element. For instance it may be in the form of two or more separate pin-form elements. The size of the suction device is generally chosen to be appropriate to the environment of the plant roots, whether it is a slab of growth substrate or a body of water.

It is also possible that the suction device is not a suction plug but is provided by a layer of material along the base of a slab. For instance, a growth substrate slab may be provided from mineral wool in which the top part has low density (eg from 10 to 100 kg/m³, in particular 20 to 60 kg/m³) and a base layer has higher density (eg at least 150 kg/m³, for instance 250 to. 350 kg/m³). Such a layer may be provided in individual slabs or in a single large slab arranged to carry a large number of plants. This system is preferably applied with a lower layer formed from mineral wool, but can be formed from any material suitable for formation of a suction plug.

The suction device is connected to one end of a first conduit, which generally has a narrow diameter. Inner diameter is preferably from 1 to 10 mm, more preferably from 2 to 6 mm, in particular about 4 mm.

The other end of the first conduit is connected to a second conduit. In the invention it is essential that the second conduit is at least partially filled with air. This allows the pressure in the system to be controlled by an air pump. It is also essential that the first conduit discharges into air space in the second conduit so that in the preferred system where several first conduits feed into a single second conduit there is no continuous water pathway between plants. Generally the first conduit is connected with the top of the second conduit. Generally also the first conduit is substantially full of water during water flow in use.

The relative volumes of air and water in the conduit system will vary according to the required water flow and the dimensions of the conduits. However, preferably not more than 80%, more preferably not more than 60%, in particular not more than 40%, of the internal volume of the conduit system is taken up by water. Most preferably less than 20%, in particular less than 10%, of the internal conduit volume is taken up by water.

The pressure in the conduit system is generally from 200 Pa below to 200 Pa above atmospheric pressure, preferably from 100 Pa below to 100 Pa above atmospheric pressure. It is preferably below atmospheric pressure, for instance from 5 to 50 Pa below atmospheric pressure.

It is possible to provide a system in which the air pressure within the conduits is above atmospheric, provided that the discharge point from the first conduit into the second conduit is at a lower elevation than the suction plug. This means that gravitational force causes the water to move from the suction plug to the second conduit. Pressure above atmospheric pressure will reduce this tendency but provided that the overall force causes water to tend to move to the second conduit then any combination of elevation and air pressure may be used.

If the pressure in the conduit system is below atmospheric pressure then the discharge point from the first conduit into the second conduit may be at a greater elevation than the suction device.

For optimum operation of the preferred system comprising two or more suction devices each associated with a first conduit, the two or more first conduits discharging into a single second conduit, the difference in elevation between the suction device and the point at which the first conduit discharges into the second conduit should be the same for each suction device/first conduit combination. It is not necessary that all the suction devices are at the same elevation as each other or that all of the first conduits are at the same elevation as each other. However the relative elevation of the end of the first conduit with respect to the suction device should be essentially the same for all pairs.

It will be seen that the skilled person will be able to choose the relative elevations of the suction device and the discharge point from the first conduit into the second conduit and the air pressure in the conduit system to obtain the desired force to draw water from the suction device to the second conduit.

It is preferred that the height of the discharge point from the first conduit into the second conduit is no lower than any other point in the first conduit. That is, preferably no part of the first conduit is at a higher elevation than the discharge point into the second conduit.

Preferably the system comprises a number of slabs of growth substrates such as mineral wool, each provided with a suction device and a first conduit, all of the first conduits leading into a single second conduit. More preferably a series of such systems is provided so that at least two, generally several second conduits all feed into a single third conduit. Water then flows into the third conduit, in which is positioned a siphon which removes water from the system. The siphon is preferably placed at the lowest point of the third conduit.

The second conduit may be positioned at any angle provided that it allows water to flow out of the system or, as is preferable, into a third conduit. Generally it is positioned at an angle of from 0 to 45° with the horizontal.

The water siphoned from the system is generally recycled, usually after disinfection.

The system may be started by any suitable means for inducing the initial flow of water through the suction device, eg. use of an air pump or other suction means or even gravity alone. In well-sealed systems no additional means for reducing or increasing air pressure is necessary, but in practice it is often convenient to include such means to control pressure in the system over a long period of time.

An air pump is preferably used to control pressure in the system and may be connected at any point in the conduit system, usually to the second or third conduit. It is often convenient to connect it to the third conduit. The air pump is regulated to control the air pressure within the desired range within the system.

In the invention water is drawn from the growth substrate into the conduit system by means of adjusting the forces so that the water tends to travel from the suction device to the second conduit. It will also be seen that it is possible to produce a system in which the pressure in the conduit system is great enough that air will be forced through the suction device and into the body of water in contact with the plant roots. This can increase the oxygen level of the water around the roots in a different way.

The system of the invention may be used in any cultivation method. It is particularly useful for controlling water flow rate in the oxygen management system discussed in our co-pending International. Patent Application Number . . . filed today, reference LAS01250WO, claiming priority from British Patent Application, No. 0117182.6.

A system of the invention will now be illustrated by reference to the drawings.

### DETAILED DESCRIPTION OF THE DRAWINGS

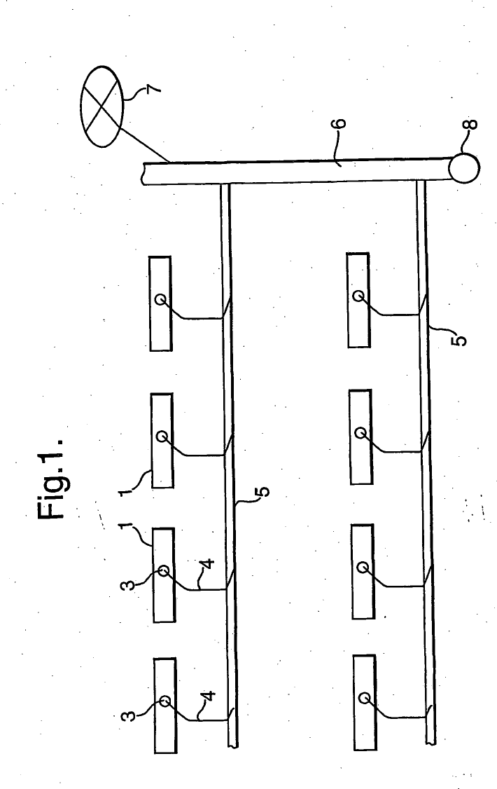

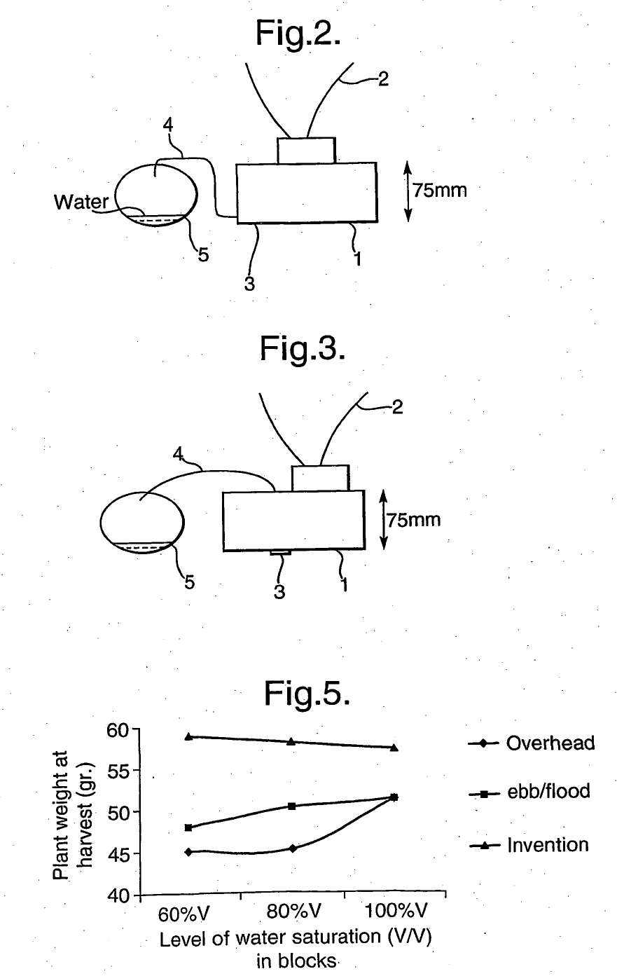

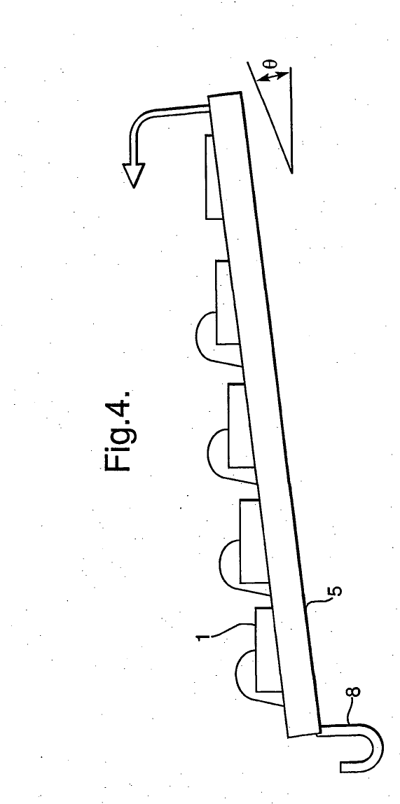

FIG. 1 shows a series of slabs 1 of mineral wool growth substrate. In each slab 1 a plant 2 is placed for growth (see FIG. 2). In each slab there is provided a suction plug 3 connected with a first conduit 4. The first conduits 4 all join a single second conduit 5, described as a lateral conduit. In a preferred system there is a series of lateral conduits 5 into each of which a series of first conduits feed water. Two lateral conduits 5 are shown in FIG. 1. The lateral conduits 5 all feed into a third conduit 6. The third conduit is described as a main conduit. Connected to this main conduit 6 is an air pump 7. At the lowest point of the main conduit 6 is a siphon 8 used to remove water.

The first conduits 4 generally have inner diameter from 1 to 10 mm, preferably about 4 mm. The second lateral conduits 7 generally have inner diameter from 20 to 80 mm, preferably from 40 to 80 mm.

The system is set up as follows. The siphon 8 is filled with water. The slabs 1 are filled with water. This allows the suction plugs ˜3 to be filled with water from the slabs 1 by capillary action. The air pump 7 is then started so as to lower the air pressure in the conduit system. The air pressure is lowered to, for example, about 10 Pa below atmospheric pressure. Consequently water from the suction plugs 3 is drawn into the first conduits 4 as a result of the lower pressure in the conduit system and drips into the lateral conduit 5 at the top of the lateral conduit 5. FIG. 2 has a cross-section through lateral conduit 5 showing the air space and the water flowing along the bottom of the conduit. Thus the water removed from each slab is isolated from all other slabs. The water flows along the base of the lateral conduit 5 and into the main conduit 6. Water is removed from the system by means of the siphon 8, which allows water to exit regardless of the air pressure and without influencing the air pressure.

In the illustrated system the point at which the first conduits 4 discharge into the lateral conduits 5 is at a greater elevation than the suction plugs 3. Thus in order to draw water through the first conduit 4 it is necessary that the air pressure is below atmospheric pressure to a sufficient extent to raise the water through the required elevation. The relative elevation is the same for all suction plug/first conduit pairs. Thus the pressure in the conduit system may even be atmospheric pressure, provided that the overall force on the water tends to draw it from the suction plug to the lateral conduit 5.

The siphoned water is usually disinfected and recirculated.

### EXAMPLE

This example illustrates the use of a system according to the invention to control the water content of growth substrate blocks. It demonstrates that use of the system of the invention gives significant improvements in plant weight at harvest in comparison with two other (known) methods of watering.

In the tests described cucumber plants were grown in blocks of stone wool growth substrate of dimensions 10 cm×10 cm×7.5 cm. Water is supplied to the blocks by three different methods—(a) the ebb/flood method, (b) the overhead method and (c) the method of the invention. In each case the system was controlled so as to aim for a predetermined percentage of water in the blocks of growth Substrate.

The ebb/flood (a) and overhead (b) systems are known methods in the prior art for maintaining a predetermined water content in blocks of growth substrate.

The ebb/flood system (a) is carried out by means of measuring the weight of each block twice a day. When the block reaches a weight of 400 grams this is taken as a single that the water content is too low. Flooding is carried out to ensure that the appropriate water content is achieved. When 60% water content is required flooding is carried out to a water height of 0.5 cm, when 80% water content is required flooding is carried out to a water height of 1 cm and when 100% water content is required flooding is carried out to a water height of 7.5 cm, ie the block is totally submerged. The flood is maintained for a sufficient period to allow the water content to increase to the predetermined percentage.

The overhead system (b) uses a similar technique. When the weight of a block reaches 400 grams further water is added from above the plant using a watering can. The amount of water applied is chosen according to the percentage water content required in the block.

In system (c) of the invention a system as described in the figures above is used to maintain water content constant at the defined level.

At the end of 3 weeks the weight of the blocks of growth substrate was determined, as was the plant weight.

Results are shown in FIG. 5. These clearly indicate that use of system (c) of the invention gives a significant increase in plant weight (10 to 20%) in comparison with ebb/flood system (a) and overhead system (b).

Final weight results are shown below for system (c) of the invention. Table 1 shows results for three different types of mineral wool substrate (A, B and C). The percentage water content is given in each case. Each test was replicated four times as shown by the columns R1 to R4. The mean value for the four replicates is given.

TABLE 1

| Test | Block Type | Water % | R1 | R2 | R3 | R4 | Mean |
|---|---|---|---|---|---|---|---|
| 1 | A | 60 | 383 | 338 | 336 | 377 | 359 |
| 2 | A | 80 | 461 | 485 | 480 | 489 | 479 |
| 3 | A | 100 | 599 | 507 | 559 | 588 | 563 |
| 4 | B | 60 | 250 | 274 | 316 | 322 | 290 |
| 5 | B | 80 | 461 | 471 | 494 | 487 | 478 |
| 6 | B | 100 | 583 | 594 | 614 | 586 | 594 |
| 7 | C | 60 | 329 | 329 | 307 | 314 | 320 |
| 8 | C | 80 | 342 | 443 | 444 | 490 | 430 |
| 9 | C | 100 | 462 | 595 | 581 | 495 | 533 |

The overall variation coefficient for the results as a whole was 8.1%. These results show that there is a low variation between replicates in final weight at the end of the trial, indicating the success of the system of the invention in maintaining consistent water content throughout the test.

1. A method of growing plants comprising supplying water to the plants so that the plant roots contact a body of water and drawing water through a suction device provided in contact with the body of water and into a first conduit connected at one end to the suction device and through the first conduit into a second conduit connected to the other end of the first conduit, characterised in that the second conduit is at least partially filled with air and the water is released from the first conduit into air space in the second conduit.

2. A method according to claim 1 in which the pressure in the conduits is controlled by an air pump.

3. A method according to claim 1 in which the plants are grown in a growth substrate so that the water is supplied to the growth substrate and water drawn from the growth substrate through a suction device provided in the growth substrate.

4. A method according to claim 1 in which the inner diameter of the first conduit is from 6 to 50%, preferably from 7 to 30%, of the inner diameter of the second conduit.

5. A method according to claim 1 in which the conduits are sized and the rate of flow of water is controlled so that the water takes up not more than 20%, preferably not more than 10%, of the internal volume of the conduit system.

6. A method according to claim 3 in which the growth substrate is in the form of one or more slabs provided with at least two suction devices in the form of suction plugs each of which is connected with a first conduit whereby at least two first conduits are connected with a single second conduit.

7. A method according to claim 2 in which at least two second conduits are provided and these lead into a single third conduit to which is connected the air pump.

8. A method according to claim 1 in which water is removed from the conduit system by a siphon.

9. A method according to claim 1 in which the air pressure in the conduit system is below atmospheric pressure, preferably from 0 to 200 Pa below atmospheric pressure.

10. A method according to claim 1 in which the second conduit is substantially straight and is positioned at an angle of from 0 to 45° with horizontal and has at all points elevation above the elevation of the suction device.

11. A method according to claim 1 in which the second conduit is substantially straight and is positioned at an angle of from 0 to 45° with horizontal and has an elevation at all points below the elevation of the suction device.

12. A method according to claim 1 in which the suction device holds water against a force of at least 5 cm water column, preferably at least 10 cm water column, more preferably at least 20 cm water column.

13. A method according to claim 3 in which the suction device is formed from a porous material having average pore size lower than the average pore size in the growth substrate, and is preferably formed from volcanic rock.

14. A method according to claim 3 in which the growth substrate is formed from man-made vitreous fibre, preferably stone wool.

15. An apparatus in which plants may be grown comprising a growth environment adapted to contain plants and water such that the plant roots are in contact with a body of water, the growth environment being provided with a suction device arranged to draw water from the growth environment and a first conduit connected with the suction device and arrange to draw water form the suction device and a second conduit connected to the end of the first conduit not connected with the suction device and means for draining water from the second conduit, and the apparatus is sized so that the second conduit is at least partially filled with air in use.

16. An apparatus according to claim 15 additionally comprising an air pump arranged to control the air pressure within the first and second conduits.

17. An apparatus according to claim 15 in which the growth environment is a growth substrate.

18. An apparatus according to claim 15 additionally comprising means for supplying water to the growth environment, preferably a dripper system.

19. An apparatus according to claim 15 in which the inner diameter of the first conduit is from 6 to 50%, preferably 7 to 30% of the diameter of the second conduit.

20. An apparatus according to claim 15 additionally comprising a third conduit connected with the second conduit.

21. An apparatus according to claim 20 in which the means for draining water from the second conduit comprise a siphon provided at the lowest point of the third conduit.

22. An apparatus according to claim 15 in which the suction device has any of the features recited in claim 12.

23. An apparatus according to claim 17 in which the growth substrate is man-made vitreous fibre, preferably stone wool.

24. A growth system comprising a liquid drawing and air locking device which is connected to a conduit system which is partially filled with liquid and partially filled with air and the conduit system is adapted to induce controlled release of liquid from a water-containing growth environment with which the liquid drawing and air locking device is in contact.
